(19) United States
(12) Patent Application Publication
(10) Pub. No.: US 2025/0104152 A1
(43) Pub. Date: Mar. 27, 2025

(54) SYSTEM AND METHOD FOR GENERATING ENTERPRISE FORECASTS BASED ON INPUT VARIABLES

(71) Applicant: ORACLE INTERNATIONAL CORPORATION, Redwood Shores, CA (US)

(72) Inventors: Vikas Agrawal, Hyderabad (IN); Krishnan Ramanathan, Bengaluru (IN); Jagdish Chand, Dublin, CA (US)

(21) Appl. No.: 18/680,384

(22) Filed: May 31, 2024

(30) Foreign Application Priority Data
Sep. 26, 2023 (IN) 202341064482
Sep. 26, 2023 (IN) 202341064658

(51) Int. Cl. G06Q 40/06; G06Q 10/04

(52) U.S. Cl. CPC G06Q 40/06; G06Q 10/04

(57) ABSTRACT

In accordance with an embodiment, described herein are systems and methods for generating enterprise forecasts based on an analysis of input variables and direct forecasting. In accordance with an embodiment, the system can use linear regression or other mathematical models or modeling techniques to assess a set of variables related to an enterprise forecast, and their values and rate of change of such values, within a particular forecast window. Based on such assessment, the system can generate an enterprise forecast for that time period, or for a subsequent time period.

### CLAIM OF PRIORITY AND CROSS-REFERENCE TO RELATED APPLICATIONS

This application claims the benefit of priority to India Provisional Patent Application titled “SYSTEM AND METHOD FOR GENERATING ENTERPRISE ACCOUNTING FORECASTS BASED ON INPUT VARIABLES”, application No. 202341064658, filed Sep. 26, 2023; and India Provisional Patent Application titled “SYSTEM AND METHOD FOR PROCUREMENT ASSISTANCE INCLUDING ASSESSMENT OF INVENTORY AND OTHER INPUTS”, application No. 202341064482, filed Sep. 26, 2023; and is related to U.S. patent application titled “SUPPLY CHAIN COMMAND CENTER FOR INTELLIGENT PROCUREMENT ASSISTANCE”, Inventors Vikas Agrawal et al., Attorney Docket No. ORACL-06080US0, application Ser. No. ______, filed May 31, 2024; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for generating enterprise forecasts based on an analysis of input variables and direct forecasting.

### BACKGROUND

Within a business organization, there is a need to be able to assess the accounting health of the business, including for example its incoming and outgoing expenditures or cash flow. However, there is a challenge in assessing or integrating the fixed and variable components of an enterprise cash flow, including for example accounts receivable (AR) receipts, accounts payable (AP) payments, sales orders, general ledger (GL) cash positions, GL budgets, payroll, purchase orders, and purchase requisitions.

Existing accounting products may, for example, only statically account for variable components, whereas an understanding of future AR and AP amounts is required to properly assess how much cash is expected to be received by the business, and its timing, and how much cash the business is expected to spend, and when.

### SUMMARY

In accordance with an embodiment, described herein are systems and methods for generating enterprise forecasts based on an analysis of input variables and direct forecasting.

In accordance with an embodiment, the system can use linear regression or other mathematical models or modeling techniques to assess a set of variables related to an enterprise forecast, and their values and rate of change of such values, within a particular forecast window. Based on such assessment, the system can generate an enterprise forecast for that time period, or for a subsequent time period.

In accordance with an embodiment, the described approach can be used, for example, to generate an accounting forecast such as an indication of cash flow position for a business organization, to help examine whether the business can afford a certain expense either today or a month later; when might money need to be borrowed to accommodate cash shortfalls; when should suppliers be paid; when might the business be in a position to pay back its loans; whether there is a variance between forecasted performance and actual performance; or whether there may be cash leakage or wastage.

### BRIEF DESCRIPTION OF THE DRAWINGS

FIG. 1 illustrates an example data analytics system or environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 illustrates an example use of a data analytics environment, in accordance with an embodiment.

FIG. 9 illustrates a system and method for generating enterprise forecasts, in accordance with an embodiment.

FIG. 10 further illustrates the generation of enterprise forecasts, in accordance with an embodiment.

FIG. 11 further illustrates the generation of enterprise forecasts, in accordance with an embodiment.

FIG. 12 further illustrates the generation of enterprise forecasts, in accordance with an embodiment.

FIG. 13 further illustrates the generation of enterprise forecasts, in accordance with an embodiment.

FIG. 14 illustrates an example process or algorithm for generating enterprise forecasts, in accordance with an embodiment.

FIG. 15 illustrates the use of a process or algorithm for generating enterprise forecasts, in accordance with an embodiment.

FIG. 16 further illustrates the use of a process or algorithm for generating enterprise forecasts, in accordance with an embodiment.

FIG. 17 illustrates the use of a process or algorithm for generating enterprise forecasts, in accordance with an embodiment.

FIG. 18 further illustrates the use of a process or algorithm for generating enterprise forecasts, in accordance with an embodiment.

FIG. 19 illustrates an example use of a procurement lifecycle, in accordance with an embodiment.

FIG. 20 illustrates the use of a procurement data model or process, in accordance with an embodiment.

FIG. 21 illustrates the use of a supply chain command center, in accordance with an embodiment.

FIG. 22 illustrates a process or method generating enterprise forecasts, in accordance with an embodiment.

### DETAILED DESCRIPTION

Within a business organization, there is a need to be able to assess the accounting health of the business, including for example its incoming and outgoing expenditures or cash flow. However, there is a challenge in assessing or integrating the fixed and variable components of an enterprise cash flow, including for example accounts receivable (AR) receipts, accounts payable (AP) payments, sales orders, general ledger (GL) cash positions, GL budgets, payroll, purchase orders, and purchase requisitions.

Existing accounting products may, for example, only statically account for variable components, whereas an understanding of future AR and AP amounts is required to properly assess how much cash is expected to be received by the business, and its timing, and how much cash the business is expected to spend, and when.

In accordance with an embodiment, described herein are systems and methods for generating enterprise forecasts based on an analysis of input variables and direct forecasting.

In accordance with an embodiment, the system can use linear regression or other mathematical models or modeling techniques to assess a set of variables related to an enterprise forecast, and their values and rate of change of such values, within a particular forecast window. Based on such assessment, the system can generate an enterprise forecast for that time period, or for a subsequent time period.

In accordance with an embodiment, the described approach can be used, for example, to generate an accounting forecast such as an indication of cash flow position for a business organization, to help examine whether the business can afford a certain expense either today or a month later; when might money need to be borrowed to accommodate cash shortfalls; when should suppliers be paid; when might the business be in a position to pay back its loans; whether there is a variance between forecasted performance and actual performance; or whether there may be cash leakage or wastage.

### Data Analytics Environments

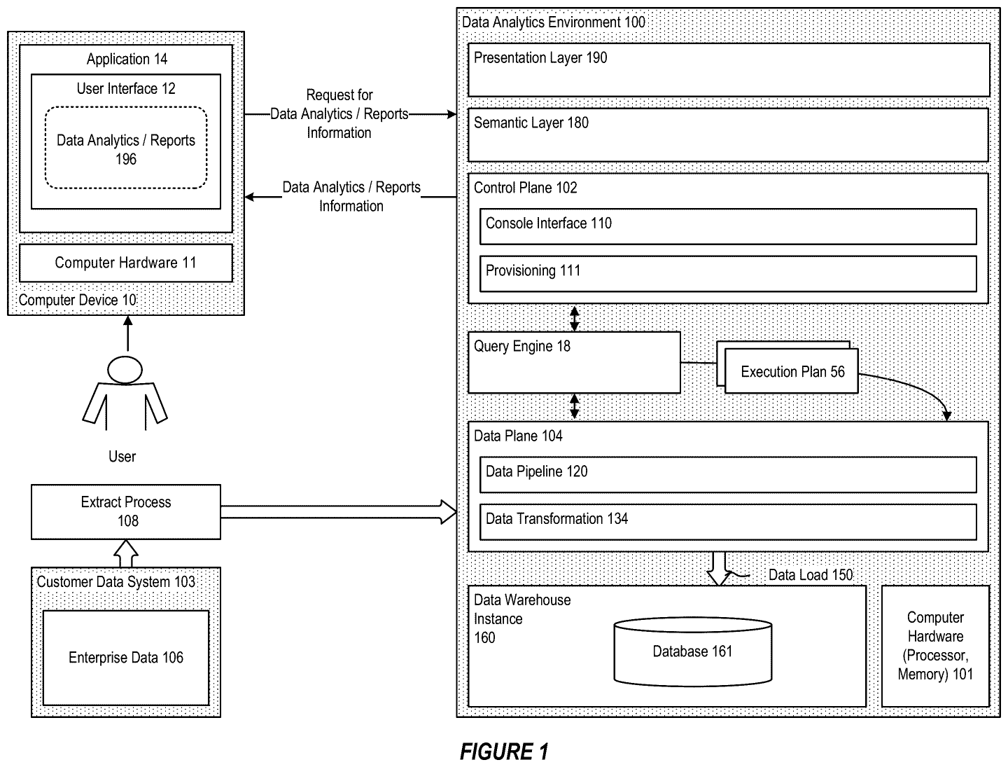

FIG. 1 illustrates an example data analytics system or environment, in accordance with an embodiment.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

The example embodiment illustrated in FIG. 1 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 1, and as further described herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160 (database 161, or other type of data source).

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (GUI) and/or a command-line interface (CLI) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer. The provisioning component can also be used to update or edit a data warehouse instance, and/or an ETL process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (KM), or other type of data model, that the system uses to transform the transactional data received from business applications and corresponding transactional databases provisioned in the SaaS environment, into a model format understood by the data analytics environment.

In accordance with an embodiment, the data plane is responsible for performing extract, transform, and load (ETL) operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract enterprise data 106 from a customer data system 103, for purposes of running data analytics thereon. For example, an extract process 108 can extract the transactional data, whereupon extraction the data pipeline or process can insert extracted data into a data staging area, which can act as a temporary staging area for the extracted data. A data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (UI) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an OBIS instance) operates in the manner of a federated query engine to serve analytical queries or requests from clients within, e.g., an Oracle Analytics Cloud environment, directed to data stored at a database.

In accordance with an embodiment, the OBIS instance can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query. In this way the OBIS instance translates business user queries into appropriate database-specific query languages (e.g., Oracle SQL, SQL Server SQL, DB2 SQL, or Essbase MDX). The query engine (e.g., OBIS) can also support internal execution of SQL operators that cannot be pushed down to the databases.

In accordance with an embodiment, a user/developer can interact with a client computer device 10 that includes a computer hardware 11 (e.g., processor, storage, memory), user interface 12, and client application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan. During operation the query engine or business intelligence server can create a query execution plan which can then be further optimized, for example to perform aggregations of data necessary to respond to a request. Data can be combined together, and further calculations applied, before the results are returned to the calling application.

in accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics information 196 to the client.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the analytics system, or in the example of a cloud environment via a cloud service provided by the environment.

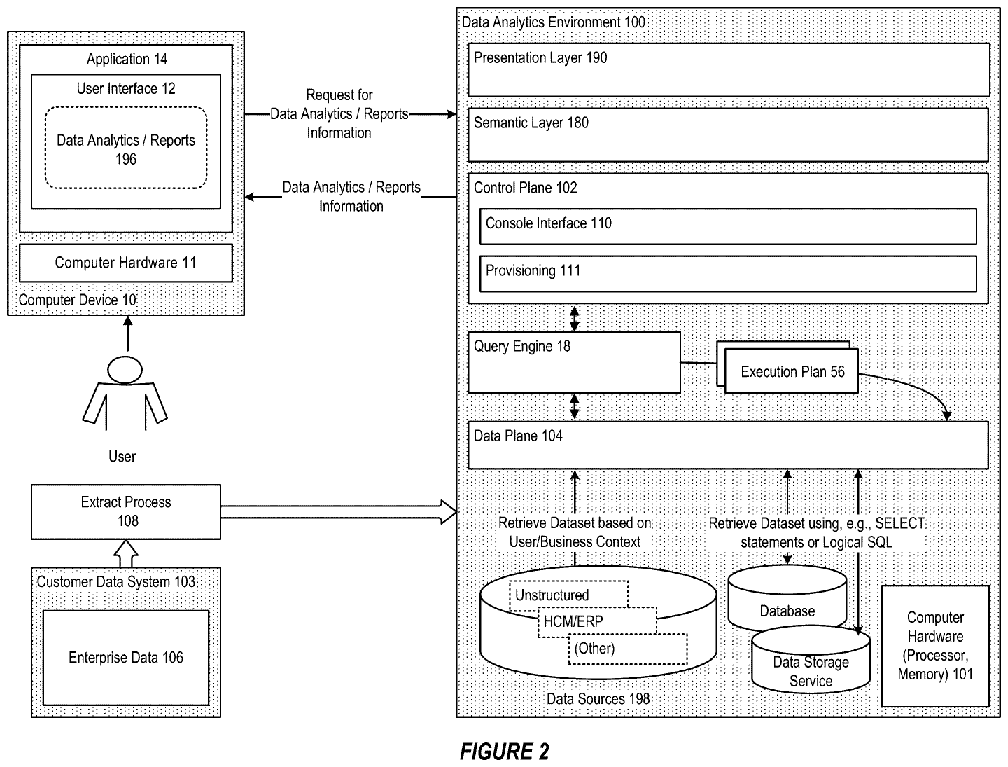

FIG. 2 further illustrates an example data analytics environment, in accordance with an embodiment.

As illustrated in FIG. 2, in accordance with an embodiment, the analytics system enables a dataset to be retrieved, received, or prepared from one or more data source(s) 198, for example via one or more data source connections. Examples of the types of data that can be transformed, analyzed, or visualized using the systems and methods described herein include HCM, HR, or ERP data, e-mail or text messages, or other of free-form or unstructured textual data provided at one or more of a database, data storage service, or other type of data repository or data source.

For example, in accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics or visualization information to the client. For example, the data analytics system can retrieve a dataset using, e.g., SELECT statements or Logical SQL instructions.

In accordance with an embodiment, the system provides functionality that allows a user to generate datasets, analyses, or visualizations for display within a user interface, for example to explore datasets or data sourced from multiple data sources.

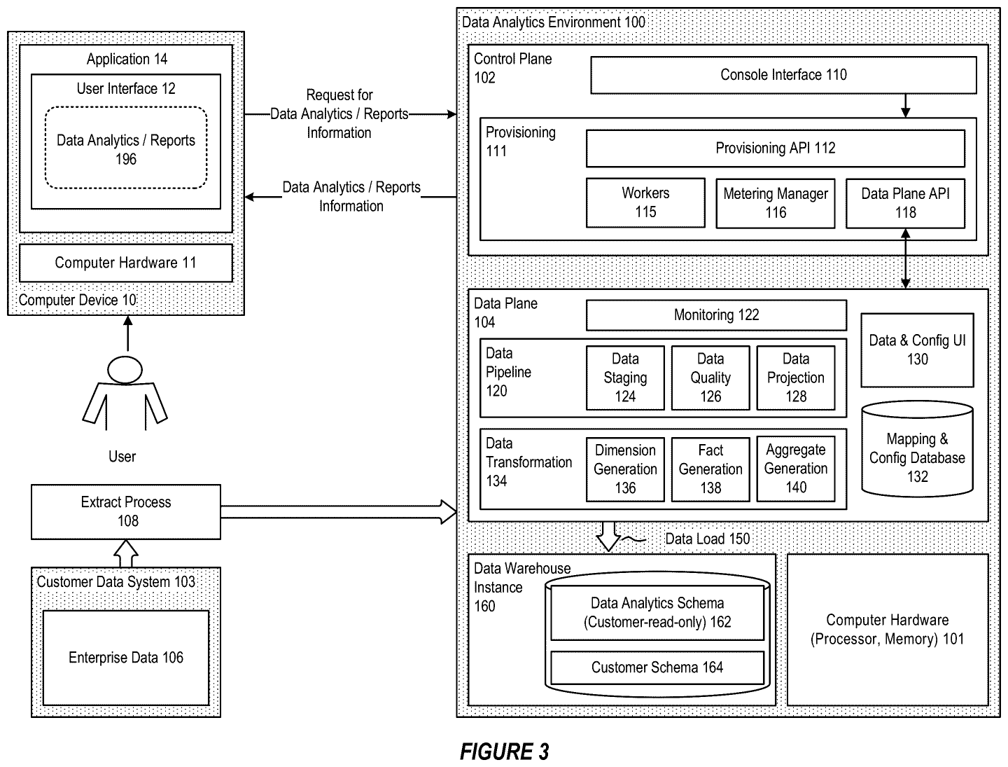

FIG. 3 further illustrates an example data analytics environment, in accordance with an embodiment.

As illustrated in FIG. 3, in accordance with an embodiment, the provisioning component can also comprise a provisioning application programming interface (API) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 126, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different data sets to be transformed. Based on the determined dependencies, the monitoring component can determine which of several different data sets should be transformed to the model format first.

For example, in accordance with an embodiment, if a first model dataset incudes no dependencies on any other model data set; and a second model data set includes dependencies to the first model data set; then the monitoring component can determine to transform the first data set before the second data set, to accommodate the second data set's dependencies on the first data set.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

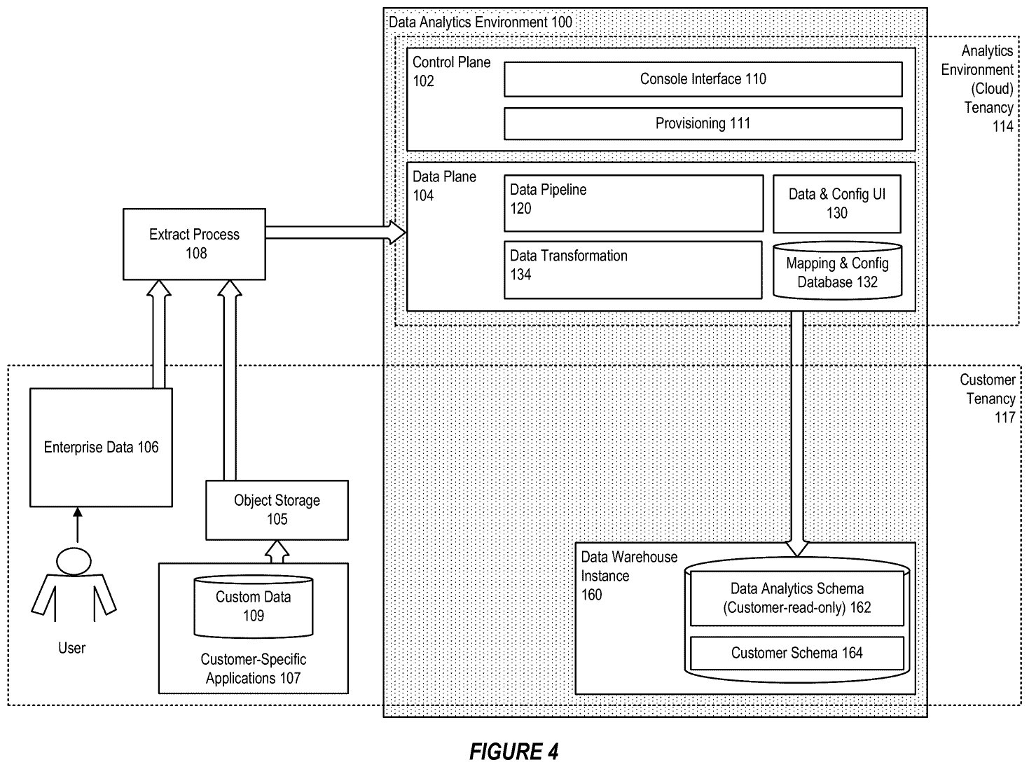

FIG. 4 further illustrates an example data analytics environment, in accordance with an embodiment.

As illustrated in FIG. 4, in accordance with an embodiment, data can be sourced, e.g., from a customer's (tenant's) enterprise data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (OAC), a user can create a data set that uses tables from different connections and schemas. The system uses the relationships defined between these tables to create relationships or joins in the data set.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

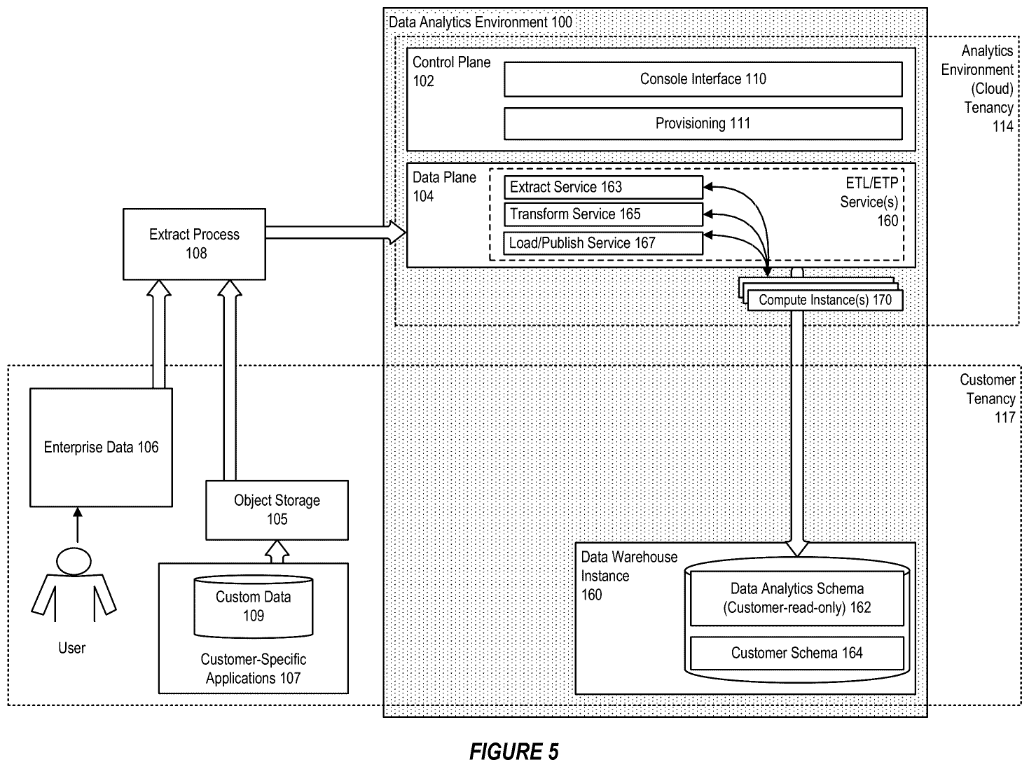

FIG. 5 further illustrates an example data analytics environment, in accordance with an embodiment.

As illustrated in FIG. 5, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (BICC) component via a ReST call. The extracted files can be uploaded to an object storage component, such as, for example, an Oracle Storage Service (OSS) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

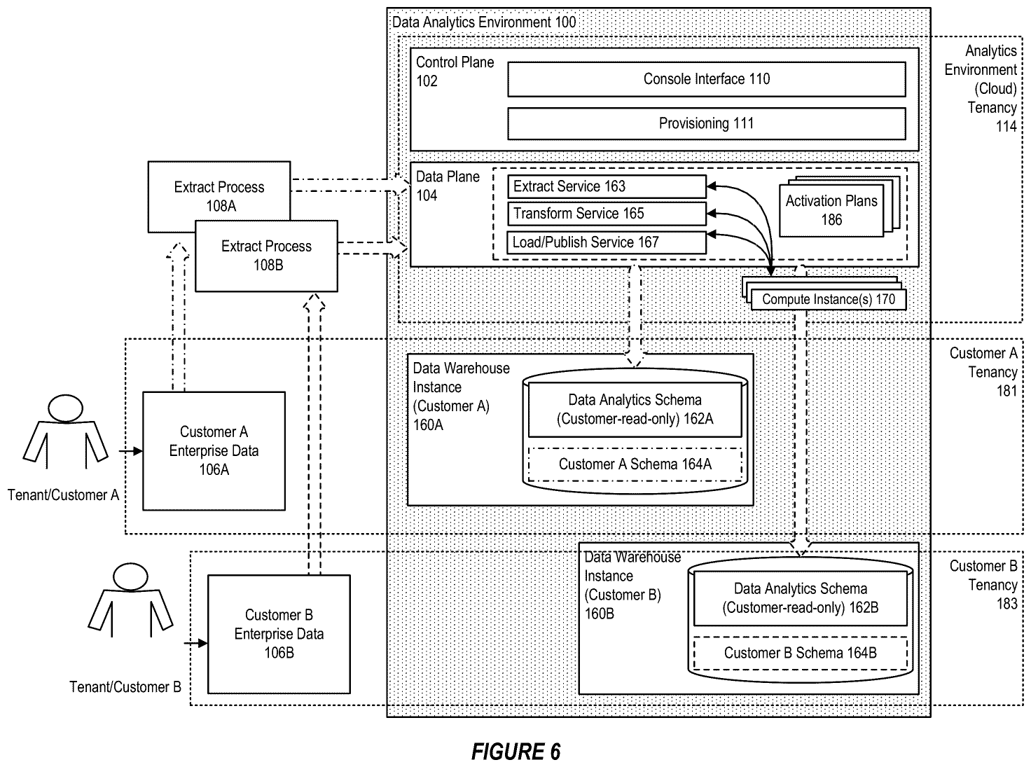

FIG. 6 further illustrates an example data analytics environment, in accordance with an embodiment.

As illustrated in FIG. 6, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A, customer B, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the enterprise data 106A, 106B within that customer's enterprise application environment, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

### Generation of Enterprise Forecasts

Within a business organization, there is a need to be able to assess the accounting health of the business, including for example its incoming and outgoing expenditures or cash flow. However, there is a challenge in assessing or integrating the fixed and variable components of an enterprise cash flow, including for example accounts receivable (AR) receipts, accounts payable (AP) payments, sales orders, general ledger (GL) cash positions, GL budgets, payroll, purchase orders, and purchase requisitions.

Existing accounting products may, for example, only statically account for variable components, whereas an understanding of future AR and AP amounts is required to properly assess how much cash is expected to be received by the business, and its timing, and how much cash the business is expected to spend, and when.

In accordance with an embodiment, described herein are systems and methods for generating enterprise forecasts based on an analysis of input variables and direct forecasting.

In accordance with an embodiment, the system can use linear regression or other mathematical models or modeling techniques to assess a set of variables related to an enterprise forecast, and their values and rate of change of such values, within a particular forecast window. Based on such assessment, the system can generate an enterprise forecast for that time period, or for a subsequent time period.

In accordance with an embodiment, the described approach can be used, for example, to generate an accounting forecast such as an indication of cash flow position for a business organization, to help examine whether the business can afford a certain expense either today or a month later; when might money need to be borrowed to accommodate cash shortfalls; when should suppliers be paid; when might the business be in a position to pay back its loans; whether there is a variance between forecasted performance and actual performance; or whether there may be cash leakage or wastage.

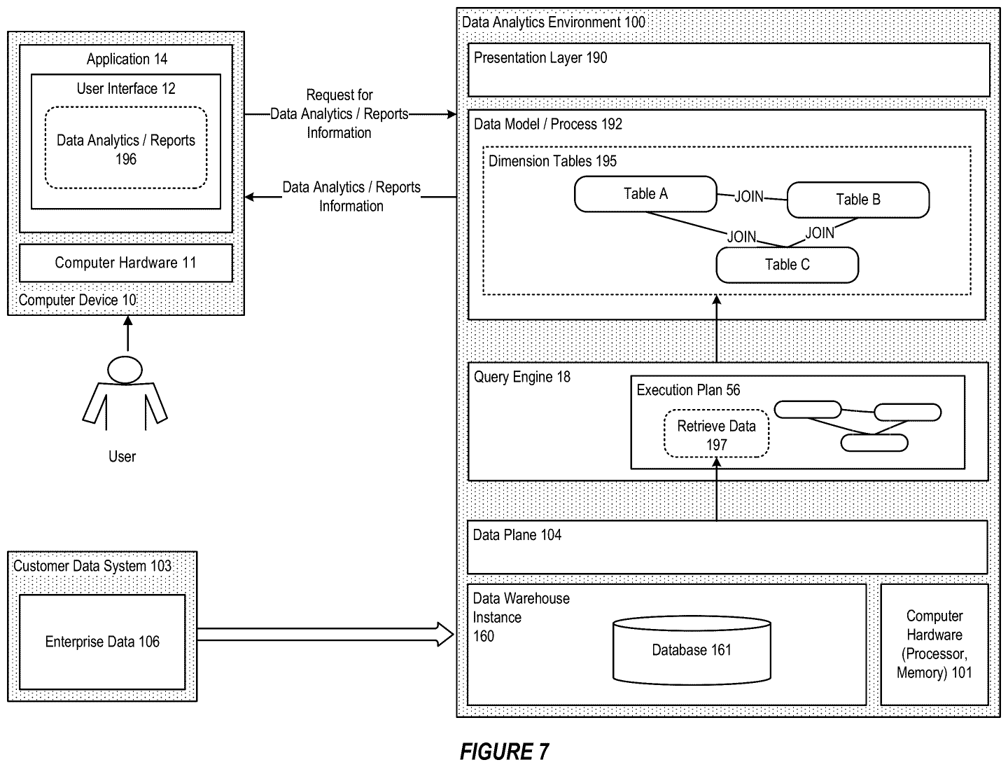

FIG. 7 further illustrates an example data analytics environment, in accordance with an embodiment.

As illustrated in FIG. 7, in accordance with an embodiment, data may be provided in one or more data tables, wherein the system can use a data model or process 192, joins, or other functionality, to retrieve 197 data from various tables 195.

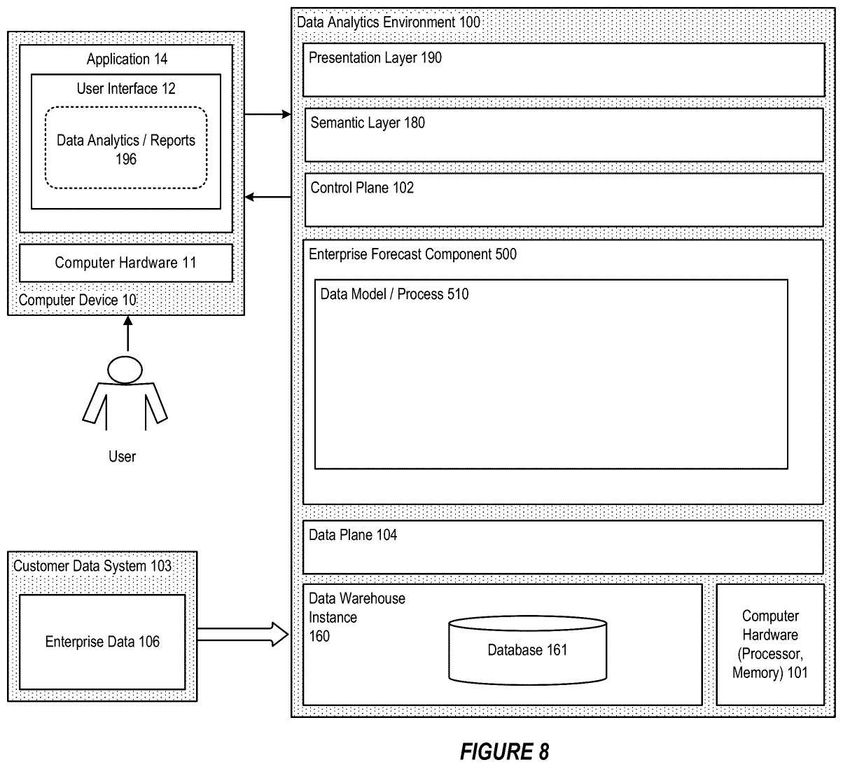

FIG. 8 illustrates an example use of a data analytics environment, in accordance with an embodiment.

As illustrated in FIG. 8, in accordance with an embodiment, the data analytics environment can be used in combination with an enterprise forecast component 500 that uses a data model or process 510 to determine an enterprise forecast. as further described below.

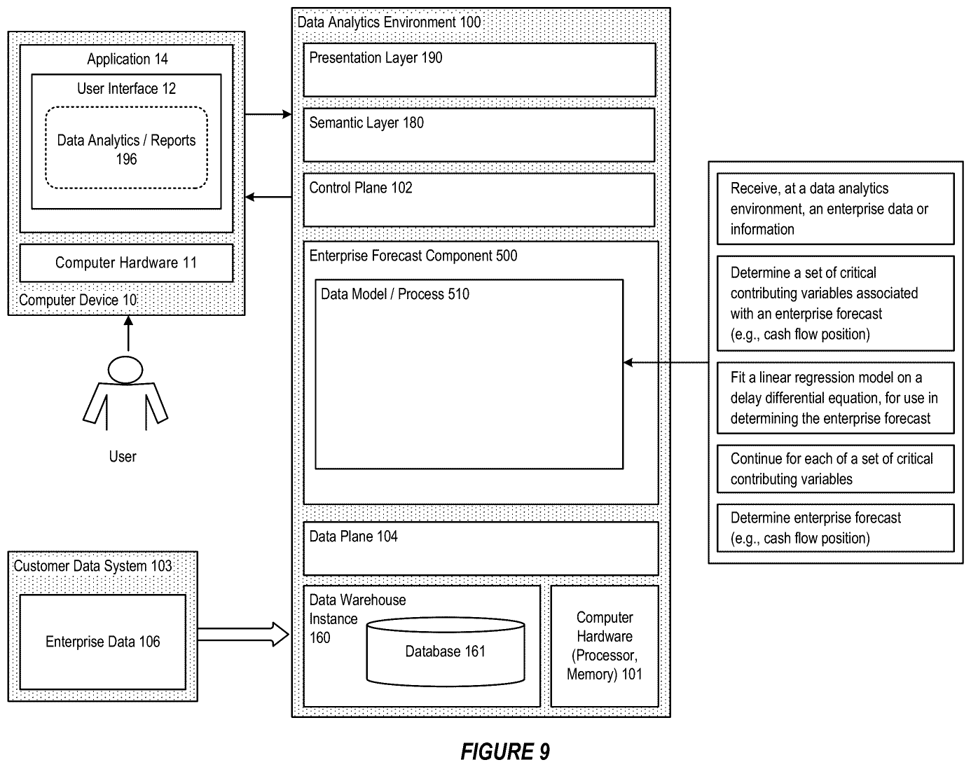

FIGS. 9-13 illustrate a system and method for generating enterprise forecasts, in accordance with an embodiment.

As illustrated in FIG. 9, in accordance with an embodiment, the system can include an enterprise forecast component 500 that receives an enterprise data or information 505, and uses a data model or process 510 to perform a method comprising: determining a set of critical contributing variables associated with an enterprise forecast; fitting a linear regression or other mathematical models on a delayed combination of previous values, differentials (rates, derivatives), accumulations (summation, integration) based relationships, for use in determining the enterprise forecast; continuing for each of a set of critical contributing variables; and using the outcome of the linear regression model to determine the enterprise forecast.

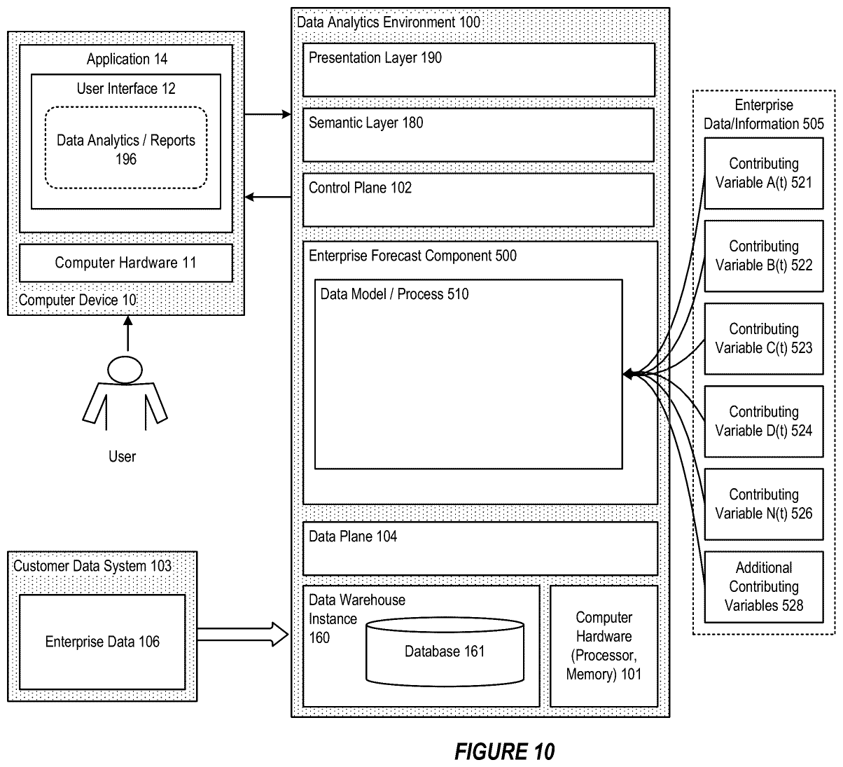

As illustrated in FIG. 10, in accordance with an embodiment, the set of critical contributing variables provided by the enterprise data or information can include, for example, contributing variables A(t) 521, B(t) 522, C(t) 523, D(t) 524, N(t) 526, or additional contributing variable 528.

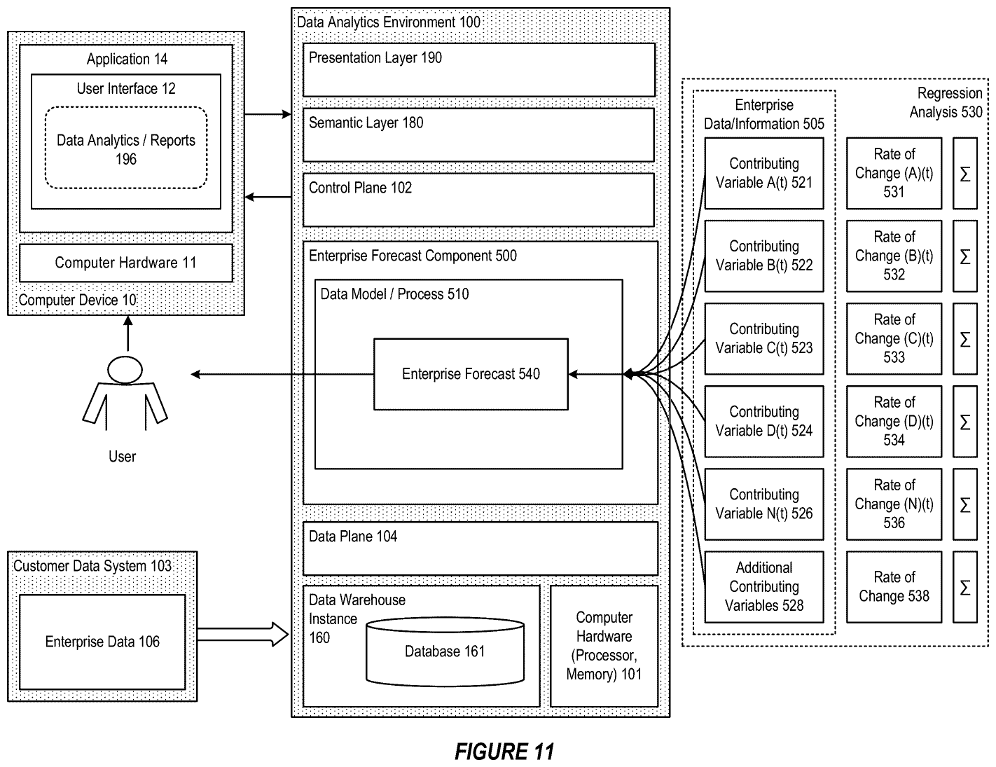

As illustrated in FIG. 11, in accordance with an embodiment, the process can include fitting a linear regression or other mathematical models on a delayed combination of previous values, differentials (rates, derivatives), accumulations (summation, integration) based relationships, for use in determining the enterprise forecast, including calculating a rate of change (531, 532, 533, 534, 536, 538) and summation for each contributing variable, to determine an enterprise forecast 540.

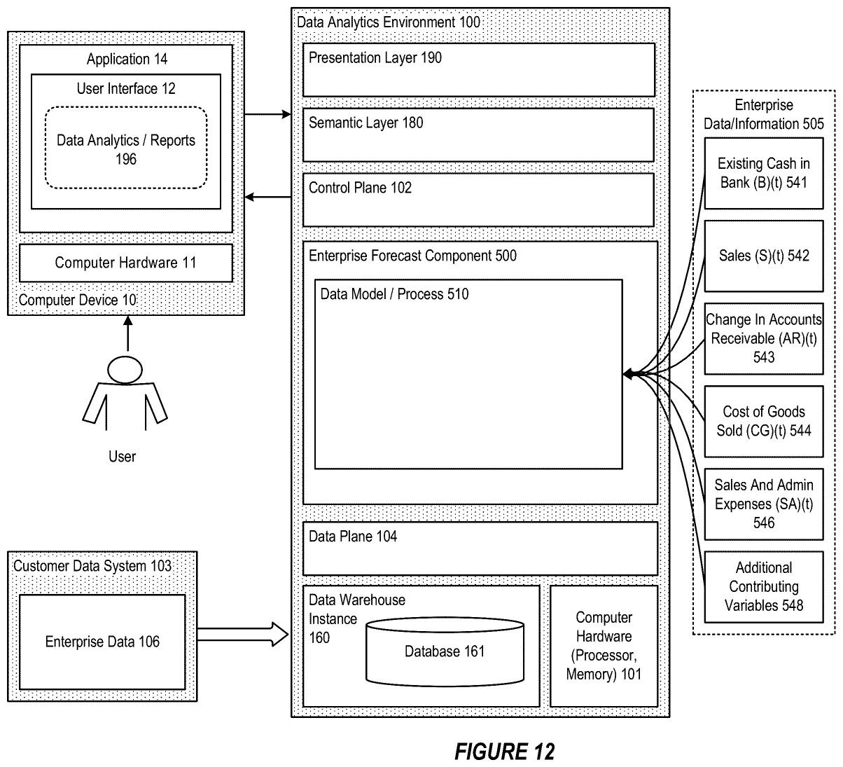

As illustrated in FIG. 12, in accordance with an embodiment, by way of example, the contributing variables can include, for example, data defining an existing Cash in Bank (B)(t) 541, Sales(S)(t) 542, ChangeInAccountsReceivable (AR)(t) 543, CostofGoodsSold (CG)(t) 544, SalesAndAdminExpenses (SA)(t) 546, and/or additional contributing variable 548.

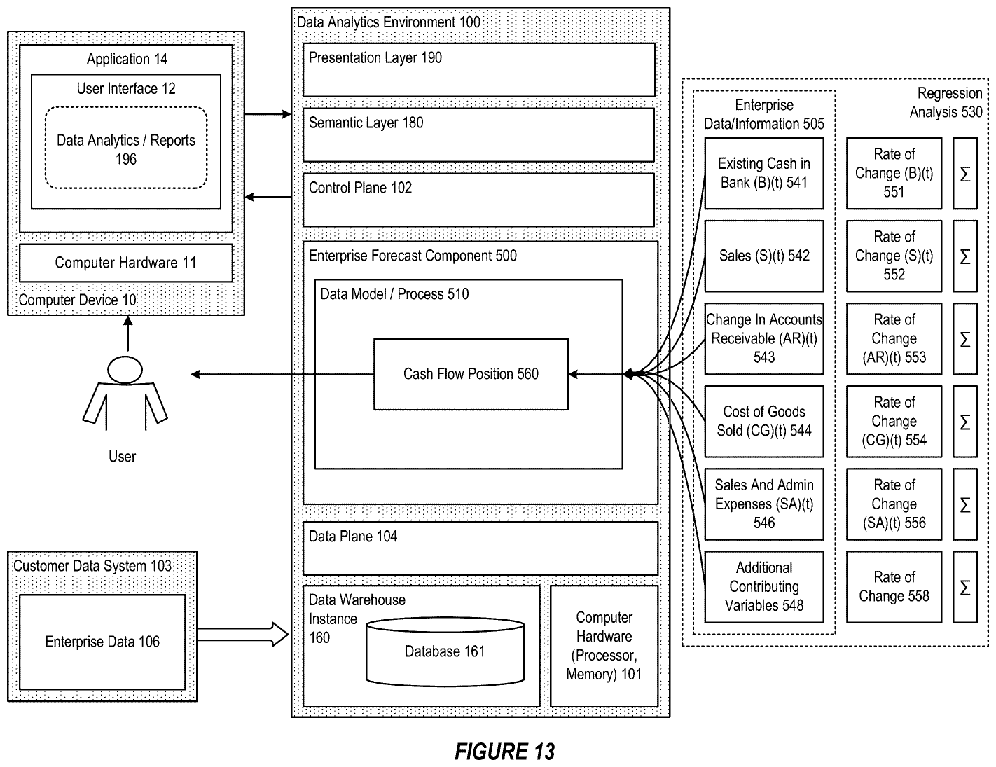

As illustrated in FIG. 13, in accordance with an embodiment, the process can include fitting a linear regression model on a delayed combination of previous values, differentials (rates, derivatives), accumulations (summation, integration) based relationships, including calculating a rate of change (551, 552, 553, 554, 556, 558) and summation for each contributing variable, to determine a cash flow position 560.

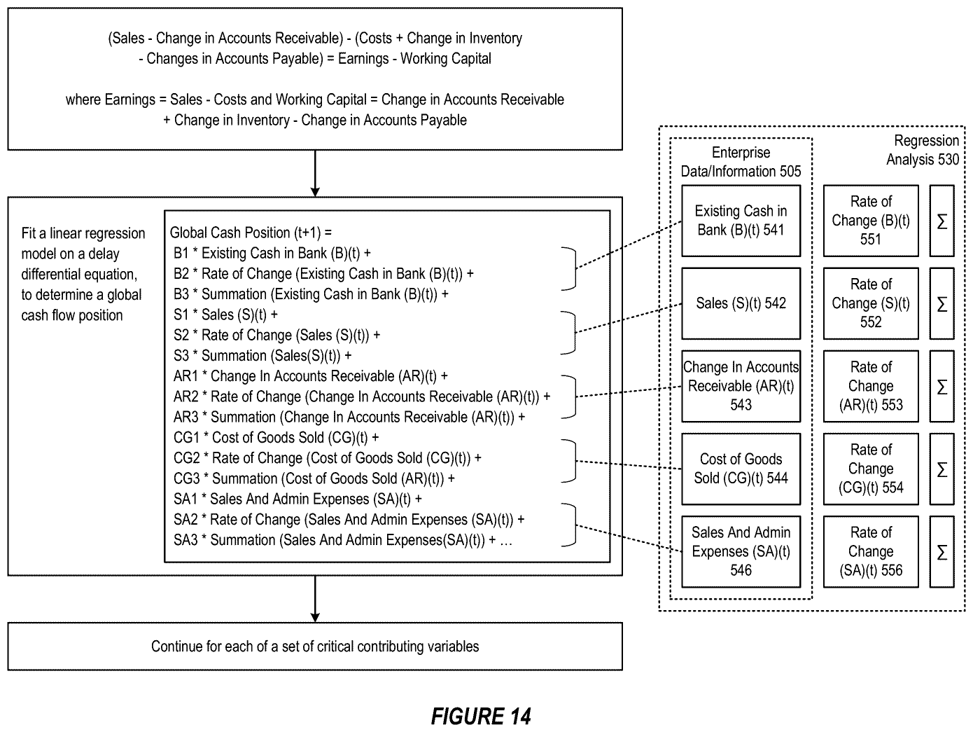

FIG. 14 illustrates an example process or algorithm for generating enterprise forecasts, in accordance with an embodiment.

In order to provide an accurate enterprise forecast for a company it may be desirable to provide answers to cash flow questions. For example, if the assessed cash flow position is not correct it affects the company's ability to purchase stock, or they may have to sell assets to cover. Certain entities are paid before or after other entities. An additional factor to consider is cost of capital-if a company needs cash now it may cost them more money to cover an associated loan. If a company does not accurately know its cash position, then it may not be able to take advantage of certain business opportunities as they arise.

In accordance with an embodiment, for purpose of creating a cash flow forecast the system can consider all of the fixed components, and all of the variable components. These cannot be simply added and subtracted; so instead the system can utilize a prediction model.

In accordance with an embodiment, the summation as illustrated below is created on the basis of a forecast window. For example, time is measured in number (#) of week or months, wherein the subscript (t) for a quantity refers to the value for the current number (#) of the week or month and (t+1) refers to the value of prediction for the next week or month. The rate of change at a time (t) is calculated in the forecast window (t−1) to (t). The summation at time (t) is calculated in the rolling quarterly window t−3 or t−13 depending on whether (t) is measure in weeks or months.

In accordance with an embodiment, the system can use a delay difference method, which includes for each variable, taking the derivative of that variable (rate of change), taking the integration of that variable (summation); and performing a linear regression or using other mathematical methods; and then continuing for the other variables.

In accordance with an embodiment, using the model, it can be found by the system that for some variables the rate of change is particularly relevant to the cash flow position. A coefficient can be chosen for those variables in order to optimize the model.

In accordance with an embodiment, when the system assesses rate of change it can determine value for (t) to estimate how far back it should assess the data to determine rate of change. For example, if the system is used to look at a next three quarters i.e. t+3, it may be appropriate to look at t−3 previous quarters.

As illustrated in FIG. 14, in accordance with an embodiment, as a first step, it can be determined at a gross level that:

(Sales−Change in Accounts Receivable)−(Costs+Change in Inventory-Changes in Accounts Payable)=Earnings−Working Capital
Where:

Earnings=Sales−Costs
and

Working Capital=Change in Accounts Receivable+Change in Inventory−Change in Accounts Payable

In accordance with an embodiment, the system can then operate to fit a linear regression model on a delayed combination of previous values, differentials (rates, derivatives), accumulations (summation, integration) based relationships. For example:

Global Cash Position (t+1)=B1*Existing Cash in Bank (B)(t)+B2*Rate of Change (Existing Cash in Bank (B)(t))+B3*Summation (Existing Cash in Bank (B)(t))+

S1*Sales(S)(t)+S2*Rate of Change (Sales(S)(t))+S3*Summation (Sales(S)(t))+

AR1*Change in Accounts Receivable (AR)(t)+AR2*Rate of Change (Change in Accounts Receivable (AR)(t))+AR3*Summation (Change in Accounts Receivable (AR)(t))+

CG1*Cost of Goods Sold (CG)(t)+CG2*Rate of Change (Cost of Goods Sold (CG)(t))+CG3*Summation (Cost of Goods Sold (CG)(t))+

SA1*Sales And Admin Expenses (SA)(t)+SA2*Rate of Change (Sales And Admin Expenses (SA)(t))+SA3*Summation (Sales And Admin Expenses (SA)(t))+

AP1*Changes in Accounts Payable (AP)(t)+AP2*Rate of Change (Changes in Accounts Payable (AP)(t))+AP3*Summation (Changes in Accounts Payable (AP)(t))+

INV1*Changes in Inventory (INV)(t)+INV2*Rate of Change (Changes in Inventory (INV)(t))+INV3*Summation (Changes in Inventory (INV)(t))+

PAY1*Changes in Payroll (PAY)(t)+PAY2*Rate of Change (Changes in Payroll (PAY)(t))+PAY3*Summation (Changes in Payroll (PAY)(t))+

OPEX1*Operating Expenses Not Included in Sales, Admin, and COGS (OPEX)(t)+OPEX2*Rate of Change (Operating Expenses Not Included in Sales, Admin, and COGS (OPEX)(t))+OPEX3*Summation (Operating Expenses Not Included in Sales, Admin, and COGS (OPEX)(t))+

DA1*Depreciation and Amortization (D&A)(t)+DA2*Rate of Change (Depreciation and Amortization (D&A)(t))+DA3*Summation (Depreciation and Amortization (D&A)(t))+

CL1*Changes in Current Liabilities (CL)(t)+CL2*Rate of Change (Changes in Current Liabilities (CL)(t))+CL3*Summation (Changes in Current Liabilities (CL)(t))+

CA1*Changes in Current Assets (CA)(t)+CA2*Rate of Change (Changes in Current Assets (CA)(t))+CA3*Summation (Changes in Current Assets (CA)(t))+

IDE1*Interest Expenses on Debt (IDE)(t)+IDE2*Rate of Change (Interest Expenses on Debt (IDE)(t))+IDE3*Summation (Interest Expenses on Debt (IDE)(t))+

II1*Interest Income (II)(t)+II2*Rate of Change (Interest Income (II)(t))+II3*Summation (Interest Income (II)(t))+

STD1*Changes in Short Term Debt (STD)(t)+STD2*Rate of Change (Changes in Short Term Debt (STD)(t))+STD3*Summation (Changes in Short Term Debt (STD)(t))+

IT1*Income Tax (IT)(t)+IT2*Changes in Payable Income Tax (IT)(t)+IT3*Changes in Deferred Tax (IT)(t)

In accordance with an embodiment, the process can continue for each of a set of critical contributing variables, for example: changes in accounts payable, changes in inventory, changes in payroll operating expenses not included in sales, admin and cogs, depreciation and amortization, changes in current liabilities, changes in current assets, interest expenses on debt, interest income, changes in short term debt, income tax, changes in payable income tax, or changes in deferred tax, as shown above in the equations.

The above examples of contributing variables are provided by way of example and for purpose of illustration of the features and processes described herein; in accordance with various embodiments, the features and processes as described herein can utilize other types of contributing variables as part of its analysis.

In accordance with an embodiment, the system can assess various coefficients, including one or more of the contribution of the rate of change, the actual quantity and summation of the quantity over time for each of the inputs variables forecast using time series forecast methods, including but not limited to, for example: existing cash in bank, sales, change in accounts receivable, cost of goods sold, sales and admin expenses, changes in accounts payable, changes in inventory, changes in payroll, operating expenses not included in sales, admin and cogs, depreciation and amortization, changes in current liabilities, changes in current assets, interest expenses on debt, interest income, changes in short term debt, income tax, changes in payable income tax, changes in deferred tax.

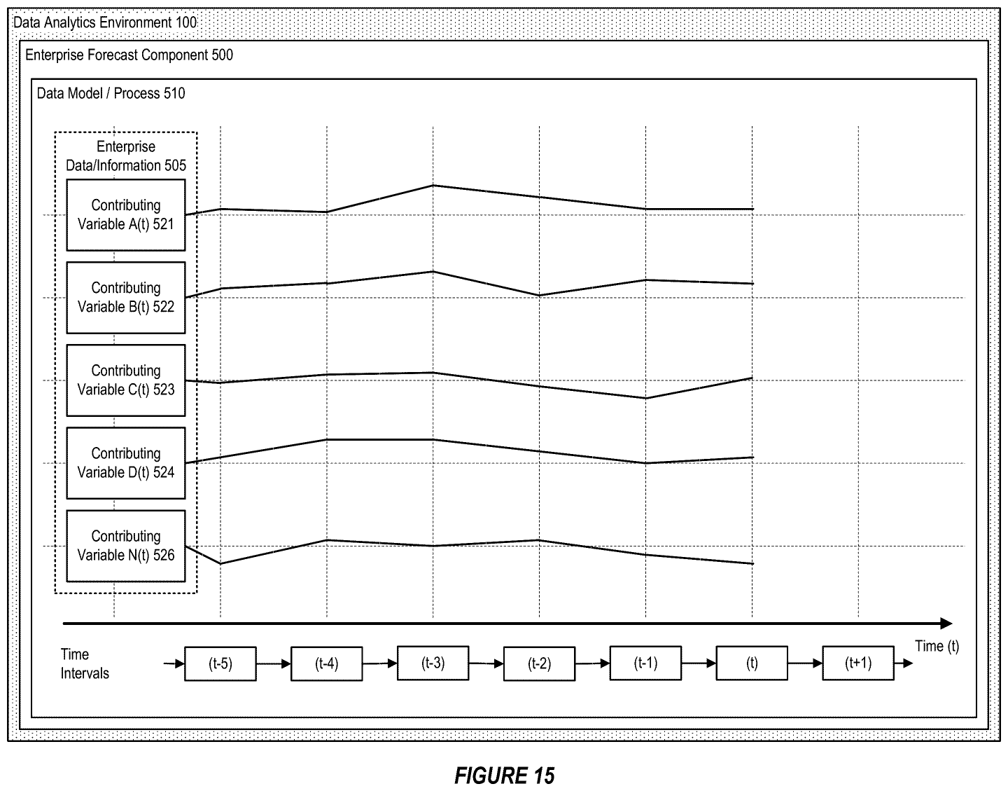

FIGS. 15-18 illustrate the use of a process or algorithm for generating enterprise forecasts, in accordance with an embodiment.

In the above model, time is measured in terms or number (#) of weeks or months. The subscript (t) for a quantity refers to the value for the number (#) of the current week or month and (t+1) refers to the value of prediction for the next week or month. All numbered values are coefficients to be fitted in a linear regression model. The rate of change at time (t) is calculated in the window (t−1) to (t). The summation at time (t) is calculated in the rolling quarterly window t−13 or t−3 depending on whether the (t) is measured in weeks or months, as a quarter has 13 weeks, but only three months,

As illustrated in FIG. 15, in accordance with an embodiment, the rate of change at time (t) is calculated in the window (t−1) to (t).

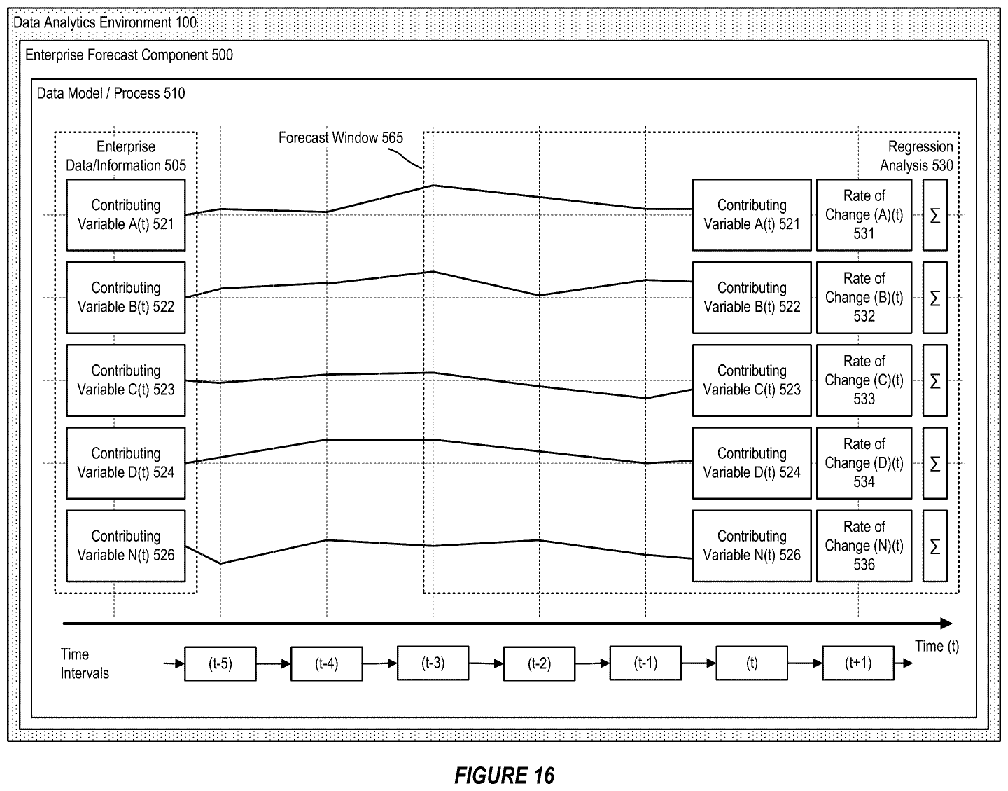

As illustrated in FIG. 16, in accordance with an embodiment, the summation at time (t) is calculated in the rolling forecast window 565, for example quarterly window t−13 or t−3 depending on whether the (t) is measured in weeks or months, as a quarter has 13 weeks, but only 3 months.

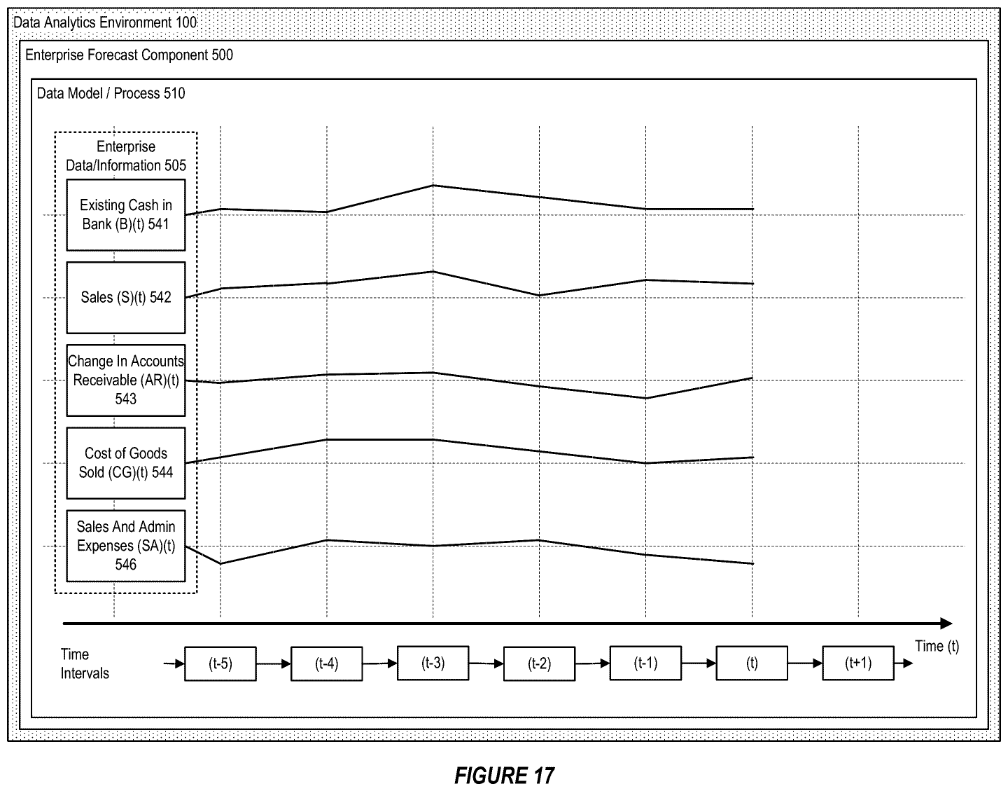

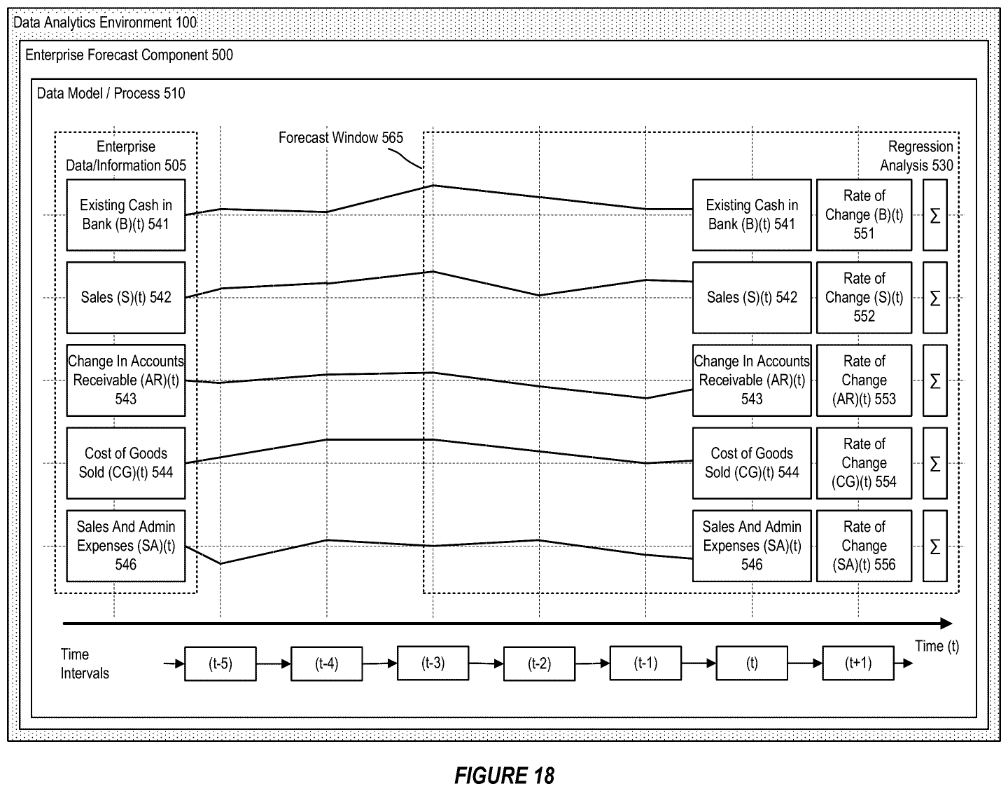

As illustrated in FIGS. 17-18, in accordance with an embodiment, the above-described approach can be used to generate an accounting forecast based on the linear regression analysis of contributing variables such as, for example, an existing Cash in Bank (B)(t) 541, Sales(S)(t) 542, ChangeInAccountsReceivable (AR)(t) 543, CostofGoodsSold (CG)(t) 544, SalesAndAdminExpenses (SA)(t) 546, and/or additional contributing variables.

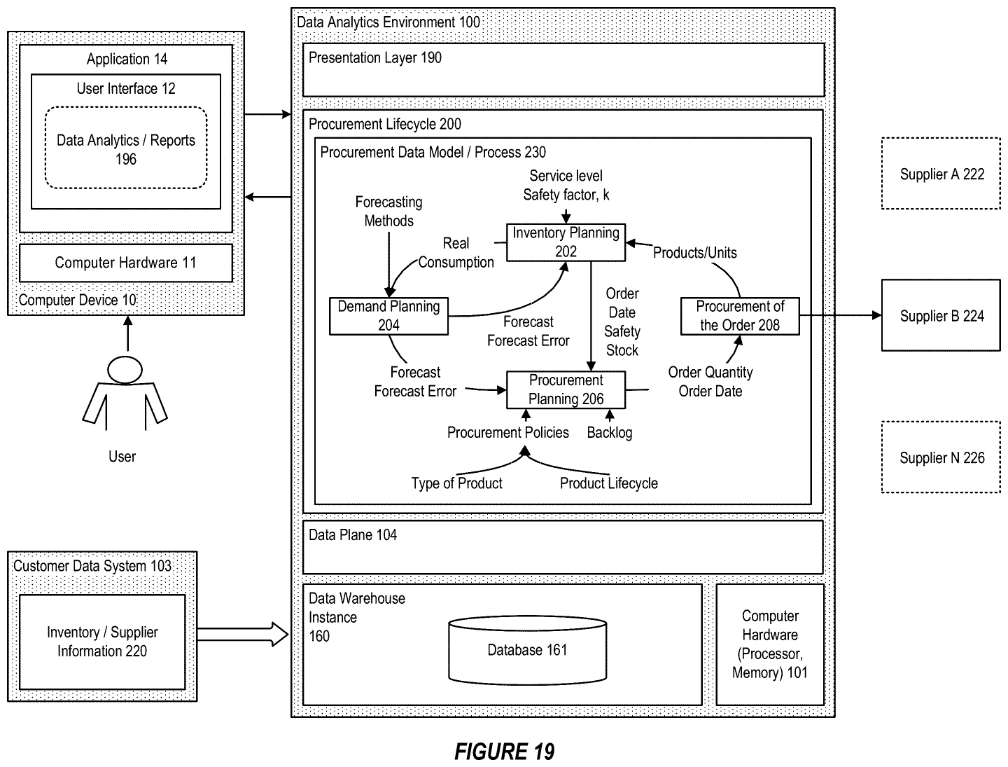

FIG. 19 illustrates an example use of a procurement lifecycle, in accordance with an embodiment.

As illustrated in FIG. 19, in accordance with an embodiment, a procurement lifecycle 200 can include, for example, an inventory planning component 202, a demand planning component 204, and a procurement planning component 206, the data or information from which can be collectively used by an order procurement component 208.

For example, in accordance with an embodiment, the inventory planning component can receive as input data a target service level, or safety factor, k, which together determine a desired level of inventory for each of a plurality of inventory items.

In accordance with an embodiment, the demand planning component can receive as input data one or more forecasting methods, together with an indication of item consumption provided by the inventory planning component.

In accordance with an embodiment, the procurement planning component can receive as input data a set of procurement polices directed to the types of items (e.g., products and product lifecycles) within an inventory, together with an indication of order dates and safety stock levels provide by the inventory planning component.

In accordance with an embodiment, the order procurement component can receive as input data an indication of order quantity and order data, and/or when an order has been completed (received), and then update the inventory planning component, for example with an indication of product or units thereof, as appropriate.

In accordance with an embodiment, the system can receive, for example from a customer data system, an inventory and supplier data or information 220 for purposes of providing procurement assistance, including for example an indication of suppliers A 222, B 224, and N 226 that can provide a particular item, such as a product or units thereof.

In accordance with an embodiment, when it is determined by the system that an inventory position is less than a safety stock level, then the system can determine an order to be placed, including for example performing a simulation to find a lowest cost (with lowest risk to achieving a target service level) associated with the order, while achieving a target service level, and then directing the order to an appropriate supplier, in this example supplier B.

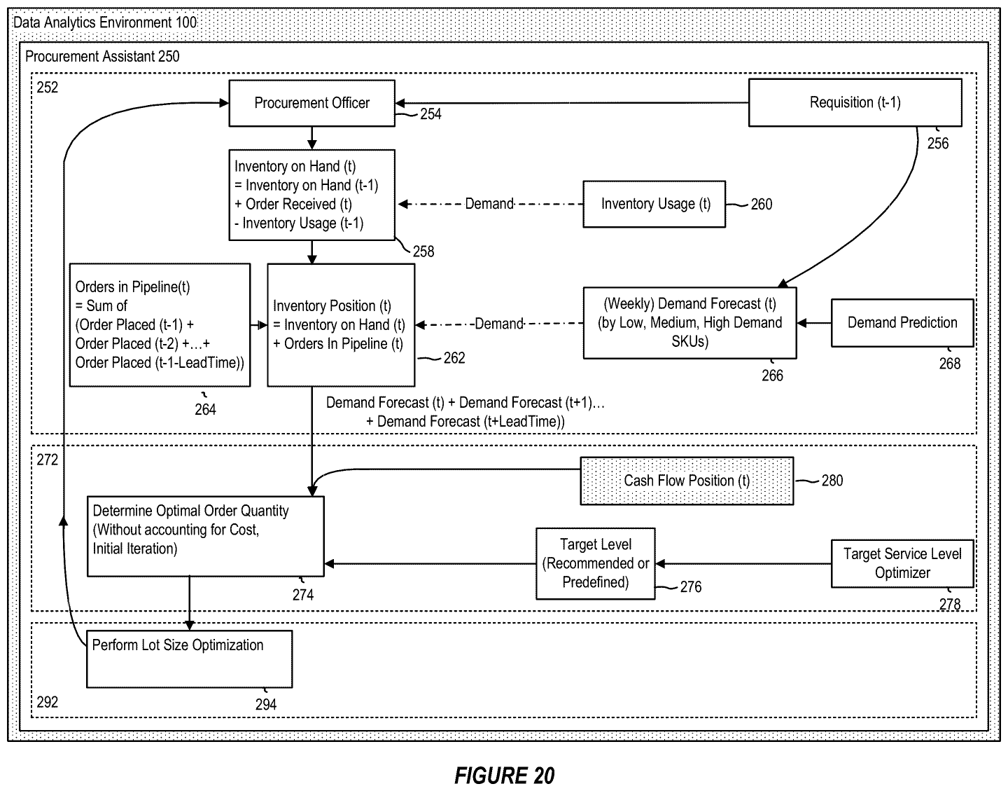

FIG. 20 illustrates the use of a procurement data model or process, in accordance with an embodiment.

As illustrated in FIG. 20, in accordance with an embodiment, a procurement assistant 250 can operate according to a procurement data model or process over multiple phases.

In accordance with an embodiment, in a first phase 252, under direction of a procurement officer 254, the system can, for each item within an inventory, and a particular time period (t): determine the inventory on hand 258, a present inventory usage (t) 260, and orders currently in the pipeline 264, in order to determine an inventory position 262.

In accordance with an embodiment, a demand forecast 266, for example as provided by a demand prediction component 268 and considering any prior requisition 256 can be used to supplement the inventory position.

In accordance with an embodiment, in a second phase 272, the system can determine, for example, that an inventory position is less than a safety stock level, and in response thereto, for each item within the inventory, and particular time period, determine an order to be placed.

In accordance with an embodiment, an order quantity component 274 can receive an input as to target level 276, for example from a target service level optimizer 278. An enterprise forecast, for example a cash flow position 280, can also be provided for use in determining an optimal order quantity.

In accordance with an embodiment, in a third phase 292, the system can perform a simulation, for example by means of a lot size optimization component 294, to find a lowest cost associated with the order, while achieving a target service level.

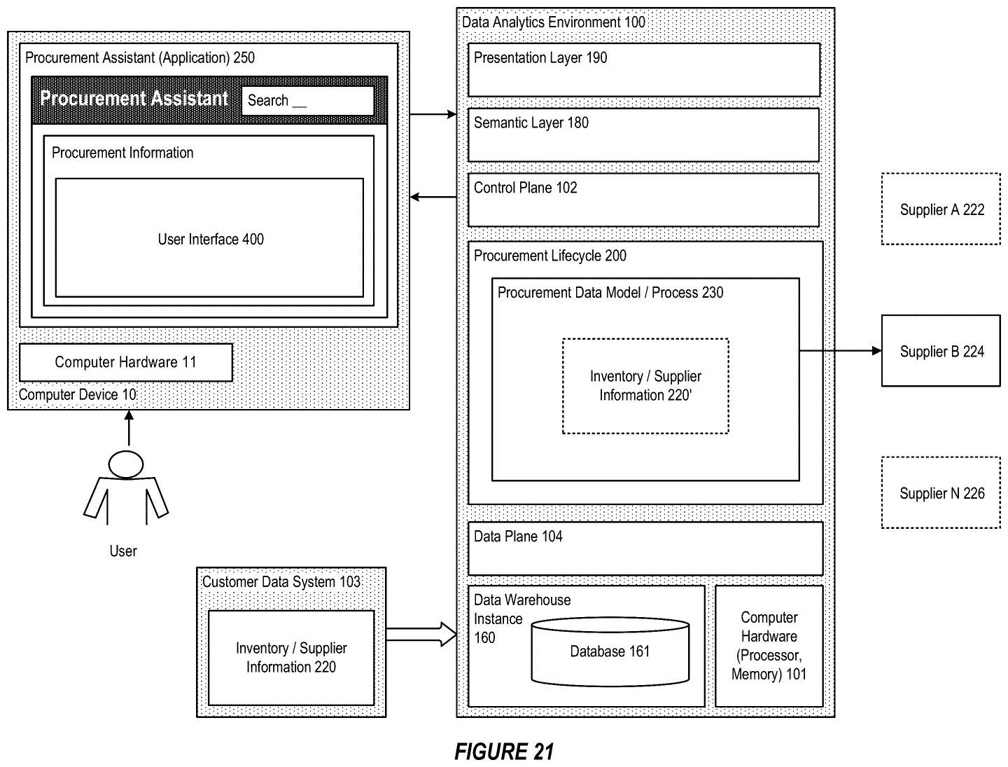

FIG. 21 illustrates the use of a supply chain command center, in accordance with an embodiment.

As illustrated in FIG. 21, in accordance with an embodiment, the system can receive from a customer data system an inventory and supplier data or information 220 for purposes of providing procurement assistance, for example providing an indication of suppliers A 222, B 224, and N 226 that can provide a particular item, such as a product or units thereof.

In the example supply chain command center for intelligent procurement assistance described above, various components can be provided within the system itself, or can be provided as separate applications or system that feed data or information into the process.

In accordance with an embodiment, an example of the environment illustrated in FIGS. 19-21 is further described in co-pending U.S. Patent Application titled “SUPPLY CHAIN COMMAND CENTER FOR INTELLIGENT PROCUREMENT ASSISTANCE”, Inventors Vikas Agrawal et al., Attorney Docket No. ORACL-06080US0, application Ser. No. ______ filed May 31, 2024, which application and the contents thereof are herein incorporated by reference.

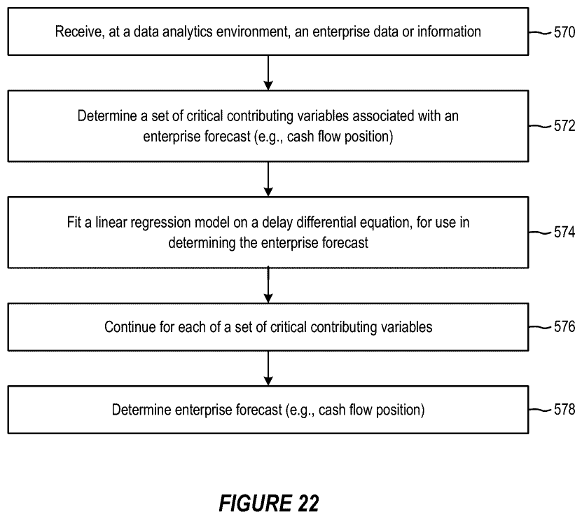

FIG. 22 illustrates a process or method generating enterprise forecasts, in accordance with an embodiment.

As Illustrated in FIG. 22, in accordance with an embodiment, the process comprises, at step 570, receiving, at a data analytics environment, an enterprise data or information.

At step 572, the system determines a set of critical contributing variables associated with an enterprise forecast (e.g., cash flow position).

At step 574, the system fits a linear regression or other mathematical model on a delayed combination of previous values, differentials (rates, derivatives), accumulations (summation, integration) based relationships, for use in determining the enterprise forecast.

At step 576, the process continues for each of a set of critical contributing variables.

At step 578, the system uses the outcome of the linear regression model to determine the enterprise forecast (e.g., cash flow position).

### Technical Advantages

In accordance with an embodiment, technical advantages of the systems and methods described herein can include:

Using the rates of changes and integration of existing variables and fitting a model to predict cash flow, in addition to the regular addition and subtraction that is commonly done.

Using dynamic forecasts of input variables, rather than using static manual guesses.

Takes away the need for guesswork from the analysts to say how much an input will change. We dynamically monitor and forecast the input with machine learning. Takes away the need for tedious collation of data and predictions from spreadsheets to machine learning models. Much higher accuracy in the cash flow prediction.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for generating enterprise forecasts, comprising:
a computer comprising one or more microprocessors, and a cloud or other computing environment operating thereon, wherein the system performs a method comprising:
receiving an enterprise data or information;
determining a set of critical contributing variables associated with an enterprise forecast;
fitting a linear regression or other mathematical models on a delayed combination of previous values, differentials, and accumulations based relationships, for use in determining the enterprise forecast;
continuing for each of a set of critical contributing variables; and
using the outcome of the linear regression model to determine the enterprise forecast.

2. The system of claim 1, wherein the linear regression assesses a set of variables related to the enterprise forecast, and their values and rate of change of such values, within a particular forecast window, and based on such assessment, the enterprise forecast is generated for that time period, or for a subsequent time period.

3. The system of claim 1, wherein the enterprise forecast comprises a cash flow position.

4. The system of claim 1, wherein the method is performed by one or more components of a data analytics environment.

5. The system of claim 1, wherein the method comprises receiving an enterprise data or information into the data analytics environment for purposes of providing cash flow position or other enterprise forecasts, and one of displaying or communicating such enterprise forecasts to other systems or processes for use thereof.

6. A method for generating enterprise forecasts, comprising:
providing a computer comprising one or more microprocessors, and a cloud or other computing environment operating thereon;
receiving an enterprise data or information;
determining a set of critical contributing variables associated with an enterprise forecast;
fitting a linear regression model on a delayed combination of previous values, differentials, and accumulations based relationships, for use in determining the enterprise forecast;
continuing for each of a set of critical contributing variables; and
using the outcome of the linear regression model to determine the enterprise forecast.

7. The method of claim 6, wherein the linear regression or other mathematical models assess a set of variables related to the enterprise forecast, and their values and rate of change of such values, within a particular forecast window, and based on such assessment, the enterprise forecast is generated for that time period, or for a subsequent time period.

8. The method of claim 6, wherein the enterprise forecast comprises a cash flow position.

9. The method of claim 6, wherein the method is performed by one or more components of a data analytics environment.

10. The method of claim 6, wherein the method comprises receiving an enterprise data or information into the data analytics environment for purposes of providing cash flow position or other enterprise forecasts, and one of displaying or communicating such enterprise forecasts to other systems or processes for use thereof.

11. A non-transitory computer readable storage medium, including instructions stored thereon which when read and executed by one or more computers cause the one or more computers to perform a method comprising:
receiving an enterprise data or information;
determining a set of critical contributing variables associated with an enterprise forecast;
fitting a linear regression model on a delayed combination of previous values, differentials, and accumulations based relationships, for use in determining the enterprise forecast;
continuing for each of a set of critical contributing variables; and
using the outcome of the linear regression model to determine the enterprise forecast.

12. The non-transitory computer readable storage medium of claim 11, wherein the linear regression assesses a set of variables related to the enterprise forecast, and their values and rate of change of such values, within a particular forecast window, and based on such assessment, the enterprise forecast is generated for that time period, or for a subsequent time period.

13. The non-transitory computer readable storage medium of claim 11, wherein the enterprise forecast comprises a cash flow position.

14. The non-transitory computer readable storage medium of claim 11, wherein the method is performed by one or more components of a data analytics environment.

15. The non-transitory computer readable storage medium of claim 11, wherein the method comprises receiving an enterprise data or information into the data analytics environment for purposes of providing cash flow position or other enterprise forecasts, and one of displaying or communicating such enterprise forecasts to other systems or processes for use thereof.
